(19) United States
(12) Patent Application Publication
(10) Pub. No.: US 2012/0190766 A1
(43) Pub. Date: Jul. 26, 2012

(54) EVM Granulated Materials As Embedding Material For Solar Modules, Method For Its Production, Adhesive Foil As Well As A Solar Module, Method For Its Production And Production Device

(75) Inventors: Andreas Roos, Dusseldorf (DE); Michael Herrmann, Koln (DE); Rainer Kalkofen, Leverkusen (DE); Stefan Kelbch, Much (DE); Hans-Jürgen Frommont, Leverkusen (DE); Gerd Bergmann, Hamburg (DE); Ralf Tappe, Kerpen (DE)

(73) Assignee: LANXESS DEUTSCHLAND GMBH, Leverkusen (DE)

(21) Appl. No.: 13/389,006

(22) PCT Filed: Aug. 3, 2010
(86) PCT No.: PCT/EP2010/061287

§ 371 Date: Apr. 17, 2012

(30) Foreign Application Priority Data
Aug. 7, 2009 (DE) 10 2009 036 534.6

(51) Int. Cl. C08L 31/04; B32B 37/00

(52) U.S. Cl. 522/37; 156/275.5; 522/46; 156/379.6; 522/33; 522/39; 522/64; 522/68; 522/40; 522/41; 522/67

(57) ABSTRACT

The invention relates to pellets of α-olefin-vinyl acetate copolymers with a vinyl acetate content of ≧40% by weight, based on the total weight of the α-olefin-vinyl acetate copolymer, as an embedding material for solar modules, wherein the pellets comprise, as additives, at least one UV activator and at least one silane coupling reagent, and to the use thereof for the production of films for solar modules.

### CROSS REFERENCE TO RELATED PATENT APPLICATIONS

The present patent application claims the right of priority under 35 U.S.C. §119 (a)-(d) and 35 U.S.C. §365 of International Application No. PCT/EP2010/061287, filed Aug. 3, 2010, which was published in German as International Patent Publication No. WO 2011/15584A1 on Feb. 10, 2011, which is entitled to the right of priority of German Patent Application No. DE 10 2009 036 533.8 filed on Aug. 7, 2009.

The present invention relates to pellets of α-olefin-vinyl acetate copolymers with a vinyl acetate content of ≧40% by weight, based on the total weight of the α-olefin-vinyl acetate copolymer, as an embedding material for solar modules, to the production process therefor, to an adhesive film and to a solar module, and to the production process and production apparatus therefor.

With the aid of solar modules which convert sunlight directly to electrical energy, natural resources are utilized to generate power. The most important constituent of solar modules is solar cells.

Solar modules are frequently used in outdoor areas, for example on buildings. The solar cells present in the solar modules therefore have to be protected from environmental influences. Since penetrating moisture can greatly shorten the lifetime of the solar cells and hence of the solar module as a result of corrosion, the permanent encapsulation (embedding) of the solar cells is of particular significance. The material used to encapsulate the solar cells must be transparent to the sunlight and simultaneously enable the inexpensive production of the solar modules. A material frequently used in the prior art to embed the solar cells is ethylene-vinyl acetate copolymers.

For example, WO-A-97/22637 relates to an essentially transparent and colourless embedding material, which is free from absorber components for ultraviolet light and is formed from a polymer component and a crosslinking reagent. The polymer component used according to WO-A-97/22637 is preferably ethylene-vinyl acetate. According to Example 1 in WO-A-97/22637, a random ethylene-vinyl acetate copolymer formed from 67% by weight of ethylene and 33% by weight of vinyl acetate is used.

EP 1 164 167 Al discloses encapsulation materials comprising an ethylene-vinyl acetate copolymer (EVA), a crosslinker and a polymerization inhibitor. According to EP 1 164 167 A1, the EVA has a vinyl acetate content of 5 to 50% by weight. At contents above 50% by weight, according to EP 1 164 167 A1, the mechanical properties of the EVA worsen, and it becomes difficult to produce EVA films. With regard to the production process for the EVA used in EP 1 164 167 A1, EP 1 164 167 A1 contains no details. According to Examples 1 and 2 in EP 1 164 167 A1, an EVA copolymer with 26% by weight of vinyl acetate is used.

EP 1 184 912 A1 likewise relates to an embedding material for solar cells, which is formed from an ethylene-vinyl acetate copolymer (EVA). According to EP 1 184 912 A1, the vinyl acetate content in the EVA copolymer is 10 to 40% by weight. Contents of more than 40% by weight of vinyl acetate are unfavourable according to EP 1 184 912 A1, since EVA copolymers with contents of more than 40% by weight of vinyl acetate flow readily and thus complicate the embedding process of the solar cells. Furthermore, EVA copolymers with a vinyl acetate content of more than 40% by weight, according to EP 1 184 912 A1, are notable in that they are tacky, and so the EVA film used for the embedding is difficult to handle. The EVA films used with preference are crosslinked according to EP 1 184 912 A1.

JP-A 2003-051605 discloses a film for a solar module, formed from an EVA copolymer mixed with an organic peroxide, a silane coupling reagent and stabilizers. The vinyl acetate content in the EVA copolymer according to JP-A 2003-051605 is 27% or more. In the examples, an EVA copolymer with a vinyl acetate content of 28% is used.

JP-A 2003-049004 relates to a flexible film which is suitable without crosslinking for embedding of solar cells. The flexible film is preferably formed from an ethylene polymer or an ethylene-α-olefin copolymer or an ethylene-acrylate copolymer. According to the description in JP-A 2003-049004, the intention is to provide alternative systems to EVA systems.

EP-A 1 783 159 A1 describes a resin film formed from EVA, which contains a photoinitiator and a silane coupling reagent; no details are given about the process for preparing the EVA.

EP 2 031 662 describes a solar module consisting of at least one layer of at least one α-olefin-vinyl acetate copolymer with a vinyl acetate content of ≧40% by weight (EVM), wherein the layer does not contain any ageing stabilizers and/or any adhesion promoters.

It is therefore an object of the invention to provide pellets which can be used as the basis for an embedding material, with which the production of solar modules can be performed in a time-saving and hence also inexpensive manner. The resulting solar modules should be notable for a good lifetime and outstanding UV stability.

Embedding material and encapsulation material are understood here to be synonyms.

Solar module and photovoltaic module are understood here to be synonyms.

To solve this problem, pellets of the type mentioned at the outset are proposed, which are used as an embedding material for solar modules, the pellets comprising, as additives, at least one UV activator and at least one silane coupling reagent.

Conventional embedding materials consist of ethylene-vinyl acetate copolymers, or EVA for short, with a vinyl acetate content of <40% by weight, based on the total weight of the α-olefin-vinyl acetate copolymer. For the crosslinking, organic peroxides are used here, which are thermally crosslinked in the course of vacuum lamination. The vacuum substantially prevents the formation of air bubbles. Decomposition products of these peroxides penetrate into the vacuum pumps in the conventional processes for producing photovoltaic modules, and as a result cause increased maintenance. Failure to do this maintenance work would lead to failure of the pumps.

It has now been found that, surprisingly, it is possible to dispense with the use of organic peroxides. In order nevertheless to ensure crosslinking of the α-olefin-vinyl acetate copolymers, at least one UV-activator is therefore added. The adhesion promoter additionally used is at least one silane coupling reagent.

The UV activators used are preferably benzophenone, 2-methylbenzophenone, 3,4-dimethylbenzophenone, 3-methylbenzophenone, 4,4′-his(diethylamino)benzophenone, 4,4′-dihydroxybenzophenone, 4,4′-bis[2-(1-propenyl)phenoxy]benzophenone, 4-(diethylamino)benzophenone, 4-(dimethylamino)benzophenone, 4-benzoylbiphenyl, 4-hydroxybenzophenone, 4-methylbenzophenone, benzophenone-3,3′:4,4′-tetracarboxylic dianhydride, 4,4′-bis(dimethylamino)benzophenone, acetophenone, 1-hydroxycyclohexyl phenyl ketone, 2,2-diethoxyacetophenone, 2,2-dimethoxy-2-phenylacetophenone, 2-benzyl-2-(dimethylamino)-4′-morpholinobutyrophenone, 2-hydroxy-2-methylpropiophenone, 2-hydroxy-4′-(2-hydroxyethoxy)-2-methylpropiophenone, 3′-hydroxyacetophenone, 4′-ethoxyacetophenone, 4′-hydroxyacetophenone, 4′-phenoxyacetophenone, 4′-tert-butyl-2′,6′-dimethylacetophenone, 2-methyl-4′-(methylthio)-2-morpholinopropiophenone, diphenyl-(2,4,6-trimethylbenzoyl)-phosphine oxide, phenylbis(2,4,6-trimethylbenzoyl)phosphine oxides, methylbenzoyl formate, benzoin, 4,4′-dimethoxybenzoin, benzoin methyl ether, benzoin ethyl ether, benzoin isopropyl ether, benzoin isobutyl ether, 4,4′-dimethylbenzil, hexachlorocyclopentadienes, alone or in combination. These UV activators are particularly suitable, since benzophenone, for example, has a relative UV absorption maximum in the range of 320 to 380 nm.

The content of UV activators should be between 0.1 phr and 10 phr, preferably between 0.1 phr and 3.0 phr, more preferably between 0.25 phr and 2.5 phr, especially preferably between 0.5 phr and 2.0 phr.

“phr” is a specialist definition and means “parts per 100 of rubber”.

In addition, the silane coupling reagent used may be vinyltriethoxysilane, vinyltrimethoxysilane, vinyltris(β-methoxyethoxy)silane, (methacryloyloxymethyl)methyldimethoxysilane, methacryloyloxymethyltrimethoxysilane, (methacryloyloxymethyl)methyldiethoxysilane, methacryloyloxymethyltriethoxysilane, 3-methacryloyloxypropyltrimethoxysilane, 3-methacryloyloxypropyltriethoxysilane, 3-methacryloyloxypropyltriacetoxysilane, methacryloyloxypropyltris-(trimethylsiloxy)silane, vinyltriacetoxysilane, vinyldimethoxymethylsilane, alone or in combination. Silane coupling reagents function as adhesion promoters, since they have bonding sites to the glass of the solar module.

The content of silane coupling reagent is between 0.05 phr and 10 phr, preferably 0.1 phr to 3.0 phr, more preferably 0.25 phr to 2.5 phr, especially preferably 0.5 phr to 2.0 phr.

The α-olefin-vinyl acetate copolymers used are notable for high vinyl acetate contents of ≧40% by weight, based on the total weight of the α-olefin-vinyl acetate copolymer. Typically, the vinyl acetate content of the α-olefin-vinyl acetate copolymers used according to the invention is ≧40% by weight to 90% by weight, preferably 40% by weight to 60% by weight, based on the total weight of the α-olefin-vinyl acetate copolymers.

The α-olefin-vinyl acetate copolymer used may, as well as the monomer units based on the α-olefin and vinyl acetate, have one or more further comonomer units (e.g. terpolymers), for example based on vinyl esters and/or (meth)acrylates. The further comonomer units are—if further comonomer units are present in the α-olefin-vinyl acetate copolymer—present in a proportion of up to 10% by weight, based on the total weight of the α-olefin-vinyl acetate copolymer, in which case the proportion of the monomer units based on the α-olefin is correspondingly reduced. It is thus possible, for example, to use α-olefin-vinyl acetate copolymers which are formed from ≧40% by weight to 98% by weight of vinyl acetate, 2% by weight to ≦60% by weight of α-olefin and 0 to 10% by weight of at least one further comonomer, where the total amount of vinyl acetate, α-olefin and the further comonomer is 100% by weight.

The α-olefins used in the α-olefin-vinyl acetate copolymers used may be all known α-olefins. The α-olefin is preferably selected from ethene, propene, butene, especially n-butene and i-butene, pentene, hexene, especially 1-hexene, heptene and octene, especially 1-octene.

It is also possible to use higher homologues of the α-olefins mentioned as α-olefins in the α-olefin-vinyl acetate copolymers. The α-olefins may additionally bear substituents, especially C₁-C₅-alkyl radicals. However, the α-olefins preferably do not bear any further substituents. In addition, it is possible to use mixtures of two or more different α-olefins in the α-olefin-vinyl acetate copolymers. However, it is preferred not to use mixtures of different α-olefins. Preferred α-olefins are ethene and propene, particular preference being given to using ethene as the α-olefin in the α-olefin-vinyl acetate copolymers.

The α-olefin-vinyl acetate copolymer used with preference in the inventive pellets is therefore an ethylene-vinyl acetate copolymer.

Particularly preferred ethylene-vinyl acetate copolymers have a vinyl acetate content of ≧40% by weight to 90% by weight.

Typically, the ethylene-vinyl acetate copolymers with high vinyl acetate contents used with preference are referred to as EVM copolymers, where the “M” in the abbreviation indicates the saturated backbone of the methylene main chain of the EVM.

The α-olefin-vinyl acetate copolymers used, preferably ethylene-vinyl acetate copolymers, generally have MFI values (g/10 min), measured to ISO 1133 at 190° C. and a load of 21.1 N, of 1 to 40, preferably 1 to 35.

The Mooney viscosities to DIN 53 523 ML 1+4 at 100° C. are generally 3 to 50, preferably 4 to 40, Mooney units.

The number-average molecular weight (Mw), determined by means of GPC, is generally 5000 g/mol to 800 000 g/mol, preferably 100 000 g/mol to 400 000 g/mol, more preferably to 500 000 g/mol.

Particular preference is given to using, in the inventive solar module, ethylene-vinyl acetate copolymers which are commercially available, for example, under the Levapren® or Levamelt® trade names from Lanxess Deutschland GmbH.

Further conventional additives, for instance fillers, light stabilizers (especially UV stabilizers), acid scavengers, coagents or ageing stabilizers, can be added.

Examples of light stabilizers may be 2-hydroxybenzophenones of the general formula

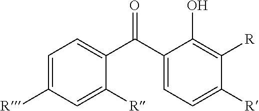

where R═H, aryl, alkyl, alkenyl or alkynyl, R′═H, aryl, alkylaryl, alkyl, alkenyl, alkynyl, OH or alkoxy; R″═H or OH and R′″═H, aryl, alkyl, alkylaryl, alkenyl, alkynyl, OH or alkoxy.

The light stabilizer is preferably 2-hydroxy-4-methoxybenzophenone.

In addition, 2-hydroxyphenylbenzotriazoles of the general formula

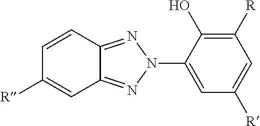

may be useful, where R═H, alkyl, aryl, alkenyl or alkynyl, R′═H, aryl, alkylaryl, alkyl, alkenyl, alkynyl, OH or alkoxy and R″═H, aryl, alkyl, alkylaryl, alkenyl, alkynyl, OH or alkoxy.

Further examples are also 4,6-diphenylhydroxyphenyltriazines of the general formula

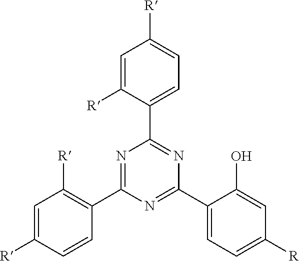

where R═H, alkyl or alkoxy, and R′═H or alkyl.

These light stabilizers are assigned to class 1.

A further example of light stabilizers is that of HALS reagents (Hindered Amine Light Stabilizer) with the formulae:

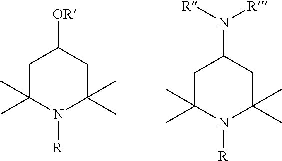

where R═H, alkyl, alkoxy. The tetramethylpiperidine units can be bridged to dimers or oligomers via R′; R″ and R′″.

These are defined hereinafter as class 2.

Preference is given to using Tinuvin 770.

Preference is given to using 0.5 to 2 phr of class 1. Particular preference is given to 0.08 to 1 phr and preferably also to 0.09 to 0.6 phr.

The amount of class 2 is preferably 0.05 to 1 phr, more preferably 0.05 to 2 phr and most preferably 0.05 to 0.4 phr.

Ideally, classes 1 and 2 can be used either individually or together, in which case the ratio of class 1 to class 2 is preferably 3:2.

It has been found that, surprisingly, in spite of the presence of UV stabilizers, UV crosslinking can be ensured. The UV stabilizers do display their protective function as a result of keto-enol tautomerism during the UV crosslinking. However, they are converted back to their original form as soon as the UV irradiation has ended. The UV stabilizers effectively “scavenge” a portion of the UV light, and later release it again. They may therefore still function as UV stabilizers in complete solar modules. In contrast, the UV activators are spent after the UV irradiation for the UV crosslinking.

It is therefore important firstly to use UV activators which are virtually consumed for the UV crosslinking, and secondly to use UV stabilizers which still have their UV protection function after the UV crosslinking.

Useful UV stabilizers are therefore all of those which have these properties.

In the case of the acid scavengers, it is possible to use polycarbodiimides (PCDs), in which case preferably 0.05 to 5 phr, more preferably 0.05 to 2 phr and very preferably 0.5 to 0.75 phr is used.

Conventional ageing stabilizers, for example Naugard TNPP, can likewise be used. The amount for use is 0.05 to 5 phr, preferably 0.5 to 2 phr and more preferably 0.5 to 1 phr.

The coagents are, for example,

triallyl isocyanurate or 1,3,5-triallyl-1,3,5-triazine-2,4,6(1H,3H,5H)-trione (TAIC) with the structural formula:

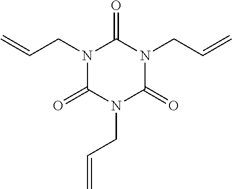

or

triallyl cyanurate, 2,4,6-triallyloxy-1,3,5-triazine (TAC), with the structural formula

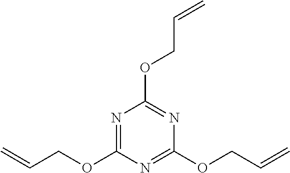

or

Trimethylolpropane trimethacrylate (TRIM) with the structural formula

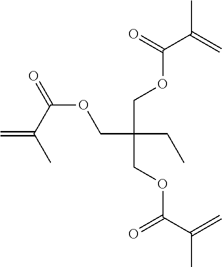

α-Olefin copolymers used with particular preference are the ethylene-vinyl acetate copolymers Levamelt® 400, Levamelt 450, Levamelt 452, Levamelt® 456, Levamelt® 500, Levamelt 600, Levamelt 686, Levamelt 700, Levamelt 800 and Levamelt® 900 with 40±1.5%, 45 ±1.5%, 50±1.5%, 60±1.5% by weight of vinyl acetate, 70±1.5% by weight of vinyl acetate, 80±2% by weight of vinyl acetate or 90±2% by weight of vinyl acetate.

It is conceivable to use a blend of α-olefin copolymers and maleic anhydride grafted onto EVM (MAHg-EVM). The MAHg-EVM content may be up to 40 parts by weight, based on the total amount of the blend. It has been found that the adhesion of the elements for the solar module can be improved.

A further invention relates to the use of the inventive pellets for production of an adhesive film, and to an adhesive film for solar modules as such.

In the production of films, three essential steps may be mentioned, namely

1. the preparation of the polymers,

2. the compounding of the polymers to give extrudable moulding materials and

3. the processing of the molding materials to give films and slabs.

“Compounding” is understood to mean the addition of dyes, fillers, lubricants, processing aids, plasticizers, ageing stabilizers, light stabilizers, flame retardants, antistats, etc. to the polymer to produce processible polymers/elastomers; this also includes alloying (mixing, blending) with other polymers or recyclates.

For example, in the extruder, the molding material is heated as pellets, powder, agglomerate or millbase, mixed, optionally degassed, and then typically extruded at elevated temperatures under pressure. Depending on the polymer, the hot extrudate is drawn off in the form of, for example, films or slabs of different thickness, and calibrated. The extrudate then runs through a cooling zone, and is subsequently cut at the side and rolled up, or stacked as slab material.

With the inventive pellets, it is possible to combine steps 1 and 2 in the film production, and in this way to save costs and time. This is because it is conceivable that the inventive pellets comprise compounding additives, such that they can then be provided as a finished moulding material for the film production.

Adhesive films produced in this way have a high weathering stability. More particularly, the embedded solar cells are protected from corrosion by barrier action against steam and oxygen.

The prior art discloses a process for preparing the useful α-olefin-vinyl acetate copolymers with a vinyl acetate content of ≧40% by weight, based on the total weight of the α-olefin-vinyl acetate copolymer, which is performed by a solution polymerization process at a pressure of 100 to 700 bar, preferably at a pressure of 100 to 400 bar, at temperatures of 50 to 150° C., generally using free-radical initiators.

Suitable preparation processes are described, for example, in EP-A 0 341 499, EP-A 0 510 478 and DE-A 38 25 450.

The α-olefin-vinyl acetate copolymers with high vinyl acetate contents prepared by the solution polymerization process at a pressure of 100 to 700 bar are notable especially for low degrees of branching and hence low viscosities. In addition, they have a randomly homogeneous distribution of their units (α-olefin and vinyl acetate).

For the production of the inventive pellets, a conventional solution polymerization process as described above is used, wherein the boiling point of the solvent should be less than the boiling points of the UV activator and of the silane coupling reagent.

The selection of the suitable solvent is of particular significance. Typically, the solvent is removed after the polymerization by evaporating under reduced pressure; this should not also remove the additives added during the production or workup, namely the UV activators and silane coupling reagents. For this reason, it is necessary that the boiling point of the solvent is below the boiling points of the additives.

If further additives are to be added during the production, the selection of the solvent should likewise be made taking account of the boiling points of these additives, in order that they are not also removed.

Preference is given to using, as solvents, tert.-butanol, methanol, benzene, toluene, methyl acetate or dialkyl sulphoxide. These solvents have the lowest free-radical transfer tendency arid can therefore be used in the continuous process of solution polymerization.

It is likewise conceivable to prepare the inventive EVM pellets in such a way that the additives are added only after the polymerization or after the workup of the solution polymers.

A further invention relates to a solar module comprising at least one adhesive film formed from the inventive pellets.

The inventive solar module may be any solar module known to those skilled in the art. Suitable solar modules are mentioned below.

In a preferred embodiment, the inventive solar module is formed from the following layers:
i) a glass substrate with a front side and back side, the front side being the side facing toward the sun in the finished solar module;
ii) a transparent adhesive film applied to the back side of the glass substrate;
iii) one or more solar cells applied to the adhesive film;
iv) a further transparent adhesive film applied to the solar cells; and
v) a protective layer; or another glass substrate in the case of glass-glass laminates,

the solar cells being embedded into the transparent adhesive films,

and one of the transparent adhesive films being formed at least from the inventive adhesive film.

The inventive solar module preferably additionally has a connection socket and a connection terminal, and also—when it is a rigid solar module—a frame, preferably an aluminium profile frame.

Suitable glass substrates are glass panes, preference being given to using single-pane safety glass (ESG). All glass substrates known to those skilled in the art are suitable, and “glass substrate” hereinafter should also be understood to mean other transparent substrates, for example polycarbonate. The “glass substrates” here may likewise possess a structured surface.

Suitable transparent adhesive films are α-olefin-vinyl acetate copolymers, especially ethylene-vinyl acetate copolymers, and at least one adhesive film, preferably both adhesive films, are formed from the inventive adhesive films which have been defined above.

Suitable solar cells are all solar cells known to those skilled in the art. Suitable solar cells are silicon cells, which may be thick-layer cells (mono- or polycrystalline cells) or thin-layer cells (amorphous silicon or crystalline silicon); semiconductor solar cells (Ga—As cells); II-VI semiconductor solar cells (CdTe cells); CIS cells (copper indium diselenide or copper indium disulphide) or CIGS cells (copper indium gallium diselenide); organic solar cells, dye cells (Grätzel cells) or semiconductor electrolyte cells (e.g. copper oxide/NaCl solution); preference is given to using silicon cells. It is possible to use all types of silicon cells known to those skilled in the art, for example monocrystalline cells, polycrystalline cells, amorphous cells, microcrystalline cells or tandem solar cells, which are formed, for example, from a combination of polycrystalline and amorphous cells.

In addition to thick-layer cells, it is possible to use thin-layer cells, concentrator cells, electrochemical dye solar cells, organic solar cells or fluorescent cells. In addition, it is possible to use flexible solar cells. The α-olefin-vinyl acetate copolymers used are—in contrast to EVA copolymers typically used in solar cells—elastomers and are therefore particularly suitable for use in flexible solar cells. The structures of the aforementioned solar cells are known to those skilled in the art.

Typically, the inventive solar module comprises a plurality of solar cells, which are connected electrically to one another, for example, by means of solder strips. The solar cells are embedded into the transparent adhesive films.

Suitable processes for producing the solar cells are known to those skilled in the art.

In addition, the inventive solar module comprises a protective layer applied to one of the transparent adhesive films. The protective layer is generally a weathering-resistant protective layer which forms the reverse side (reverse side lamination) of the solar module. It is typically a polymer film, especially a polymer composite film, for example formed from polyvinyl fluoride, e.g. Tedlar® from DuPont, or polyester and glass.

The connection socket preferably present additionally in the inventive solar module is, for example, a connection socket with a freewheeling diode or bypass diode. These freewheeling or bypass diodes are required to protect the solar module when, for example, no current is supplied by the solar module as a result of shadow or a fault.

In addition, the solar module preferably has a connection terminal which enables connection of the solar module to a solar power plant.

Finally, the solar module—when it is a rigid solar module—in a preferred embodiment has a frame, for example an aluminium profile frame, to increase the stability of the solar module.

The individual aforementioned elements of the solar module and preferred embodiments of these elements are known to those skilled in the art.

The inventive solar module is produced by customary processes known to those skilled in the art. In general, the corresponding, generally cleaned glass substrate is first provided, to which the transparent adhesive film, preferably produced from the inventive pellets, is applied. Typically, the transparent adhesive film is cut to size before application to the glass substrate. Subsequently, the solar cells are positioned on the transparent adhesive film, and they are generally connected beforehand by means of solder strips to form individual strings. Subsequently, cross-connectors which connect the individual strings to one another and lead to the connection socket are usually positioned and optionally soldered. Finally, the further transparent adhesive film, preferably likewise produced from he inventive pellets, and generally cut to size before application, is applied. Subsequently, the protective layer is applied.

The application of the individual layers is followed by a lamination of the inventive solar module. The lamination is effected by processes known to those skilled in the art, for example under reduced pressure and at elevated temperature (for example 100 to 200° C.). The lamination achieves the effect that the solar cells are embedded into the transparent adhesive films and are connected in a fixed manner to the glass substrate and the protective layer. Subsequently, the connection socket is generally positioned and the module is framed.

In the conventional lamination process, the known EVA melt-applied adhesive is melted with supply of heat and crosslinked thermally by free-radical-forming peroxides. Owing to the relatively slow crosslinking of the EVA melt-applied adhesive, the cycle times are about 20 to 30 minutes per module.

The process according to the invention for producing solar modules, in the case of the use of adhesive films which comprise at least one UV activator and at least one silane coupling reagent, can considerably shorten the cycle time, which leads to a cost saving. The shortening of the cycle time becomes possible as a result of the absence of the thermally induced peroxidic crosslinking.

The process according to the invention for producing a solar module is characterized in that the solar module is subjected to UV irradiation. The UV irradiation crosslinks the embedding material, such that the solar cells are protected from environmental influences.

The UV irradiation is preferably performed directly after the lamination. As a result, the module is already preheated and the diffusion rate of the UV activator is adjusted optimally to the UV crosslinking.

The duration of the irradiation is preferably between 10 and 600 seconds, more preferably between 10 and 180 seconds. The production of the solar modules is significantly shortened as a result, since it is possible to dispense with the relatively long crosslinking time during the lamination of a conventional EVA adhesive film.

The temperature during the UV irradiation is preferably 50° C. to 200° C. This can be achieved by preferably using the modules directly after the lamination or during the UV crosslinking, but this prolongs the irradiation time correspondingly.

However, it is also conceivable first to preheat the modules and then to crosslink them by means of the UV radiation. However, this is advisable only when the lamination cannot be performed directly before the UV irradiation for technical reasons.

It should be noted here that, for the optimal crosslinking of the modules, the irradiation time depends on the power of the UV radiator, on the distance between the UV radiator and the module, and on the irradiation area.

When UV stabilizers are added, it should additionally be ensured that the irradiation time is adjusted such that there is sufficient UV light for the UV crosslinking, since some of the UV light is “scavenged” by the UV stabilizers, as described above.

However, it should be possible for the person skilled in the art to find the optimal treatment time directly by various test series.

The process according to the invention is therefore suitable for the production of solar modules both with the inventive adhesive films and with conventional EVA films as the embedding material, these comprising at least one UV activator and at least one silane coupling reagent.

The inventive solar modules may have a structure corresponding to the abovementioned examples or else a different structure. Further types of solar modules are known to those skilled in the art. Examples are laminated glass-glass modules, glass-glass modules in casting resin technology, glass-glass modules in composite safety film technology, thin-layer modules behind glass or as a flexible coating, for example on copper ribbon, concentrator modules in which sunlight is concentrated onto smaller solar cells with the aid of optics, and fluorescence collectors.

The present invention further provides the apparatus for producing solar modules, which comprises a UV radiator.

In this context, commercial UV radiators suitable for the UV crosslinking of the pellets or adhesive films are employed.

Particularly advantageous in this context is the simple and inexpensive upgrading of conventional solar module production apparatus. It is conceivable additionally to equip an already existing semiautomatic or fully automatic module production line additionally with a UV radiator. This requires neither a costly and inconvenient modification of the existing apparatus nor the installation of a completely new apparatus, which means a considerable economic and financial advantage with regard to the time and cost factor.

The UV radiator is preferably mounted directly downstream of the lamination apparatus, for instance a vacuum laminator. In this case, the already heated solar modules are supplied directly to the UV irradiation. The irradiation temperature is thus defined by the lamination, which is in turn reflected in a time and cost saving.

The inventive apparatus is therefore suitable for the production of solar modules both with the inventive adhesive films and with conventional EVA films as the embedding material, these comprising at least one UV activator and at least one silane coupling reagent.

It is conceivable that the inventive solar modules are used for stationary and mobile power generation.

Typically, power is generated in a solar power plant which comprises at least one inventive solar module, in which the light energy from the sun is converted to electrical energy, and at least one electrical load.

The present invention therefore provides a solar power plant comprising at least one inventive solar module.

Suitable electrical loads depend on the type of the solar power plant. For example, the load may be a direct current load or an alternating current load. When an alternating current load is connected, it is necessary to convert the direct current obtained from the solar modules to alternating current by means of an inverter. It is likewise possible that solar power plants which comprise both direct current loads and alternating current loads are used,

The solar power plant may additionally be an island system which has no (direct) connection to a power grid. The power generated in an island system is typically buffered in batteries as energy stores (loads in the context of the present application). Suitable island systems are known to those skilled in the art.

In addition, the solar power plants may he grid-coupled plants, in which case the solar power plant is connected to an independent power grid and the electrical energy is fed into this power grid. In this case, the load is thus the power grid. Suitable grid-coupled plants are likewise known to those skilled in the art.

The invention is illustrated in detail hereinafter by examples.

### FORMULATION EXAMPLE FOR THE INVENTIVE PELLETS

100 phr of Levamelt

1.5 phr of benzophenone

1.5 phr of silane

TABLE 1

| | Strength (MPa) | Strain (%) |
|---|---|---|
| Unirradiated | 6.4 | 1114 |
| Irradiated | 14.3 | 660 |

Tab. 1 shows the stress/strain behaviour of inventive pellets before and after UV irradiation. The exposure setting of the irradiated sample was 3 minutes. The sample was preheated at 140° C. for 10 min, then irradiated with an Fe@2 kW UV lamp from Hönle for the duration of 3 min, with a distance of 10 cm from the UV lamp,

TABLE 2

| Time (s = second) | ML1 + 4/100° C. (ME) |
|---|---|
| Unirradiated | 18 |
| 10 s | 34 |
| 60 s | 88 |
| 90 s | 105 |

Tab. 2 shows an increase in the Mooney viscosity as a function of the irradiation time of the Levapren 400 in the case of addition of 1.0 phr of UV crosslinker, which is irradiated by means of an Fe@2kW UV lamp from Hönle at a distance of 10 cm from the UV lamp.

TABLE 3

| Benzophenone (phr) | 0.5 | 1 | 2 | 4 | 7 |
|---|---|---|---|---|---|
| Strength (MPa) | 15.4 | 14.8 | 15.9 | 6.6 | 3.0 |
| Strain (%) | 754 | 694 | 631 | 513 | 371 |

Tab. 3 shows the change in the tensile strain behaviour with different amounts of UV crosslinker in the case or irradiation for 1 min. by means of an Fe@2kW UV lamp from Hönle with a distance of 10 cm from the UV lamp,

TABLE 4

| Irradiation time (s = seconds) | 10 | 20 | 30 | 40 | 50 | 90 |
|---|---|---|---|---|---|---|
| Strength (MPa) | 14.1 | 15.1 | 16.5 | 17.3 | 18.3 | 19.5 |
| Strain (%) | 835 | 817 | 768 | 738 | 717 | 713 |

Tab. 4 shows the change in the tensile strain behaviour with different illumination times of the composition from Tab. 2, with an Fe@2kW UV lamp from Hönle at a distance of 10 cm from the UV lamp.

What is claimed is:

1. Pellets of α-olefin-vinyl acetate copolymers with a vinyl acetate content of ≧40% by weight, based on the total weight of the α-olefin-vinyl acetate copolymer, as an embedding material for solar modules, characterized in that the pellets comprise, as additives, at least one UV activator and at least one silane coupling reagent.

2. Pellets according to claim 1, characterized in that the UV activator is selected from benzophenone, 2-methylbenzophenone, 3,4-dimethylbenzophenone, 3-methylbenzophenone, 4,4′-bis(diethylamino)benzophenone, 4,4′-dihydroxybenzophenone, 4,4′-bis[2-(1-propenyl)phenoxy]benzophenone, 4-(diethylamino)benzophenone, 4-(dimethylamino)benzophenone, 4-benzoylbiphenyl, 4-hydroxybenzophenone, 4-methylbenzophenone, benzophenone-3,3′,4,4′-tetracarboxylic dianhydride, 4,4′-bis(dimethylamino)benzophenone, acetophenone, 1-hydroxycyclohexyl phenyl ketone, 2,2-diethoxyacetophenone, 2,2-dimethoxy-2-phenylacetophenone, 2-benzyl-2-(dimethylamino)-4′-morpholinobutyrophenone, 2-hydroxy-2-methylpropiophenone, 2-hydroxy-4′-(2-hydroxyethoxy)-2-methylpropiophenone, 3′-hydroxyacetophenone, 4′-ethoxyacetophenone, 4′-hydroxyacetophenone, 4′-phenoxyacetophenone, 4′-tert-butyl-2′,6′-dimethylacetophenone, 2-methyl-4′-(methylthio)-2-morpholinopropiophenone, diphenyl-(2,4,6-trimethylbenzoyl)-phosphine oxide, phenylbis(2,4,6-trimethyl-benzoyl)phosphine oxides, methylbenzoyl formate, benzoin, 4,4′-dimethoxybenzoin, benzoin methyl ether, benzoin ethyl ether, benzoin isopropyl ether, benzoin isobutyl ether, 4,4′-dimethylbenzil, hexachlorocyclopentadienes, alone or in combination.

3. Pellets according to claim 1, characterized in that the silane coupling reagent is selected from vinyltriethoxysilane, vinyltrimethoxysilane, vinyltris(β-methoxyethoxy)silane, (methacryloyloxymethyl)methyldimethoxysilane, methacryloyloxymethyltrimethoxysilane, (methacryloyloxymethyl)methyldiethoxysilane, methacryloyloxymethyltriethoxysilane, 3-methacryloyloxypropyltrimethoxysilane, 3-methacryloyloxypropyltriethoxysilane, 3-methacryloyloxypropyltriacetoxysilane, methacryloyloxypropyltris-(trimethylsiloxy)silane, vinyltriacetoxysilane, vinyldimethoxymethylsilane, alone or in combination.

4. Pellets according to claim 1, characterized in that the content of UV activator is between 0.1 phr and 10 phr, preferably between 0.1 phr and 3.0 phr, more preferably between 0.25 phr and 2.5 phr, especially preferably between 0.5 phr and 2.0 phr.

5. Pellets according to claim 1, characterized in that the content of silane coupling reagent is between 0.05 phr and 10 phr, preferably between 0.1 phr and 3.0 phr, more preferably between 0.25 phr and 2.5 phr, especially preferably between 0.5 phr and 2.0 phr.

6. Use of the pellets according to any of the preceding claims for producing an adhesive film.

7. Adhesive film for solar modules, comprising pellets according to claims 1-5.

8. Process for producing the pellets according to claims 1-5, which are prepared by means of a solution polymerization process at a pressure of 100 to 700 bar, characterized in that the boiling point of the solvent is less than the boiling points of the UV activator and of the silane coupling reagent.

9. Process according to claim 8, characterized in that the solvent is removed by evaporation.

10. Process according to claim 9, characterized in that the solvent is tert-butanol, methanol, benzene, toluene, methyl acetate or dialkyl sulphoxide.

11. Process for producing the pellets according to claims 1-5, which are prepared by means of a solution polymerization process at a pressure of 100 to 700 bar, characterized in that the additives are added after the polymerization or after the workup of the solution polymer.

12. Solar module comprising at least one adhesive film according to claim 7.

13. Process for producing a solar module, characterized in that the solar module is subjected to UV irradiation, the adhesive film comprising at least one UV activator and at least one silane coupling reagent.

14. Process according to claim 13, characterized in that the UV irradiation is preferably performed directly after the lamination.

15. Process according to claim 14, characterized in that the duration of irradiation is between 10-600 seconds, preferably between 10 and 180 seconds.

16. Process according to claim 15, characterized in that the irradiation temperature is preferably 50-200° C.

17. Process according to claim 16 for producing a solar module according to claim 12.

18. Apparatus for producing a solar module, characterized in that it comprises a UV radiator,

19. Apparatus according to claim 18, characterized in that the UV radiator is preferably mounted directly downstream of the lamination apparatus.

20. Apparatus according to claim 19 for producing a solar module according to claim 12.

21. Solar power plant comprising at least one solar module according to claim 12.
